(19) United States
(12) Patent Application Publication
(10) Pub. No.: US 2003/0098643 A1
(43) Pub. Date: May 29, 2003

(54) Plasma flat lamp

(75) Inventors: Hyoung-bin Park, Kyungki-do (KR); Gi-young Kim, Chungcheongbuk-do (KR); Ji-hyun Hong, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Suwon-city (KR)

(21) Appl. No.: 10/301,634

(22) Filed: Nov. 22, 2002

(30) Foreign Application Priority Data
Nov. 22, 2001 (KR) 2001-73017

(51) Int. Cl. H01J 1/62; H01J 63/04; H01J 17/49

(52) U.S. Cl. 313/495; 313/582

(57) ABSTRACT

A plasma flat lamp includes an upper plate, a lower plate separated a predetermined distance from the upper plate, a wall portion for forming a sealed discharge space between the upper and lower plates, a discharge gas filled in the discharge space, a first pair of electrodes including a first upper plate electrode and a first lower plate electrode arranged to face each other on each of the upper and lower plates with the discharge space interposed therebetween, and a second pair of electrodes including a second upper plate electrode separated a predetermined distance from the first upper plate electrode and a second lower plate electrode separated a predetermined distance from the first lower plate electrode arranged to face each other on each of the upper and lower plates with the discharge space interposed therebetween. Thus, the plasma flat lamp according to the present invention has a stable discharge feature which is a merit of the conventional electrodes discharge flat lamp and a high luminance of light emission which is a feature of the facing surfaces discharging type, while not having a low luminance and unstable discharge feature of the conventional surface discharge type flat lamp and facing electrodes discharging flat lamp, respectively.

### BACKGROUND OF THE INVENTION

This application claims the priority of Korean Patent Application No. 2001-73017 filed Nov. 22, 2001, in the Korean Intellectual Property Office, the disclosure of which is incorporated herein in its entirety by reference.

1. Field of the Invention

The present invention relates to a plasma flat lamp, and more particularly, to a plasma flat lamp having a high luminance, a high efficiency of light emission, and a uniform distribution of luminance.

2. Description of the Related Art

Flat lamps mainly used as back-lights of LCDs have been developed into surface discharge type or facing electrodes discharge type plasma lamps, in which the entire space under a light emitting surface makes a discharge space considering the efficiency of light emission and uniformity of luminance of light emission, from the conventional edge-light or direct-light type plasma lamps using a cold cathode fluorescent lamp.

In general, the surface discharge type is advantageous in that a discharge feature is stable compared to the facing electrodes discharge type. However, the overall luminance of the surface discharge type is lower than that of the facing electrodes discharge type. As an example of a conventional surface discharge flat lamp, there is a lamp in which the overall discharge space is divided into fine discharge areas to prevent local concentration of discharge. This lamp can discharge stably. However, since the uniformity of the overall luminance of light emission is inferior due to a difference in the luminance of light emission between the fine discharge areas and a gap between the fine discharge areas, a diffusing paper or diffusing plate is needed to uniformly diffuse light (M. Ilmer et al., Society for Information Display International Symposium Digest of Technical Papers 31, 931 (2000)).

FIG. 1 shows another example of the conventional surface discharge type flat lamp. A discharge space filled with a discharge gas is formed between an upper plate 1 and a lower plate 2 separated by a wall portion 7. Electrodes 3 and 4 for discharge are formed at both sides of an inner surface of the lower plate 2. A dielectric layer 5 is formed on each of the electrodes 3 and 4. A fluorescent layer 6 is formed on each of the inner surfaces of the upper and lower plates 1 and 2. The conventional surface discharge type flat lamp having the above structure has been known to have a low luminance due to its discharge characteristic (Y. Ikeda et al., Society for Information Display International Symposium Digest of Technical Papers 31, 938 (2000)).

FIG. 2 shows an example of the conventional facing electrodes discharge type flat lamp. An upper plate 1a and a lower plate 2a are separated a predetermined distance from each other by a wall portion 7a and a discharge space is provided therebetween. Electrodes 3a and 4a for discharge are formed on inner surfaces of the upper and lower plates 1a and 2a to face each other. A fluorescent layer 6a is formed on each of the electrodes 3a and 4a. The upper and lower plates facing electrodes discharge type flat lamp having the above structure has a high luminance compared with the surface discharge type flat lamp shown in FIG. 1, but has a low efficiency of discharge and an unstable discharge due to excessive current (J. Y. Choi et al., Proceedings of the 1^{st} International Display Manufacturing Conference, 21 (2000)).

FIG. 3 shows yet another example of the conventional facing electrodes discharge type flat lamp. Electrodes 3b and 4b are formed to face each other on inner surfaces of a wall portion 7b facing each other. Each of the electrodes 3b and 4b is protected by a dielectric layer 5b. Upper and lower plates 1b and 2b are separated by the wall portion 7b. A discharge space in which a discharge between the electrodes 3b and 4b is induced is provided between the electrodes 3b and 4b. A fluorescent layer 6b is formed on each of inner surfaces of the upper and lower plates 1b and 2b. The side wall portion facing electrodes discharge flat lamp having the above structure can prevent excessive current. However, discharge is unstable, in particular, discharge tends to concentrate on a local point.

As described above, in the conventional flat lamps, it is disadvantageous that either luminance is low while discharge is stable or luminance is high while discharge is unstable.

### SUMMARY OF THE INVENTION

To solve the above-described problems, it is an object of the present invention to provide a plasma flat lamp having a high luminance and a stable discharge feature.

To achieve the above object, there is provided a plasma flat lamp comprising an upper plate, a lower plate separated a predetermined distance from the upper plate, a wall portion for forming a sealed discharge space between the upper and lower plates, a discharge gas filled in the discharge space, a first pair of electrodes including a first upper plate electrode and a first lower plate electrode arranged to face each other on each of the upper and lower plates with the discharge space interposed therebetween, and a second pair of electrodes including a second upper plate electrode separated a predetermined distance from the first upper plate electrode and a second lower plate electrode separated a predetermined distance from the first lower plate electrode arranged to face each other on each of the upper and lower plates with the discharge space interposed therebetween.

### BRIEF DESCRIPTION OF THE DRAWINGS

The above object and advantages of the present invention will become more apparent by describing in detail preferred embodiments thereof with reference to the attached drawings in which:

FIG. 1 is a sectional view of a conventional surface discharge type flat lamp;

FIG. 2 is a sectional view of a conventional upper and lower plates facing electrodes discharge type flat lamp;

FIG. 3 is a sectional view of a conventional side wall portion facing discharging type flat lamp;

FIG. 4A is a perspective view of a plasma flat lamp according to a first preferred embodiment of the present invention;

FIG. 4B is a sectional view of the plasma flat lamp of FIG. 4A;

FIG. 5 is a sectional view of a plasma flat lamp according to a second preferred embodiment of the present invention;

FIG. 6 is a perspective view of a plasma flat lamp according to a third preferred embodiment of the present invention;

FIG. 7 is a sectional view taken along line A-A of FIG. 6;

FIG. 8 is a sectional view showing a part of a modified example of a second electrode pair of the plasma flat lamp of FIG. 6;

FIG. 9 is a sectional view of a plasma flat lamp according to a fourth preferred embodiment of the present invention;

FIG. 10A is a plan view showing a modified example of an electrode adopted to a flat lamp according to the present invention;

FIG. 10B is a plan view showing another modified example of an electrode adopted to a flat lamp according to the present invention;

FIGS. 11A and 11B are graphs showing the distribution of electric potential generating when the same conditions are applied to the conventional surface discharge flat lamp of FIG. 1 and the flat lamp of the present invention shown in FIG. 5;

FIGS. 12A and 12B are graphs showing the distribution of electron density at a given instant when the same conditions of FIGS. 11A and 11B are applied to the conventional surface discharge flat lamp of FIG. 1 and the flat lamp of the present invention shown in FIG. 5;

FIGS. 13A and 13B are graphs showing the distribution of energy used to excite Xe with respect to the conventional surface discharge flat lamp of FIG. 1 and the flat lamp of the present invention shown in FIG. 5;

FIGS. 14A and 14B are diagrams showing the percentage of use of input energy in the conventional flat lamp and the flat lamp according to the present invention; and

FIG. 15 is a graph showing the result of a test between the conventional flat lamp and the flat lamp according to the present invention having the same size with respect to a Xe(4%)/Ne mixed gas.

### DETAILED DESCRIPTION OF THE INVENTION

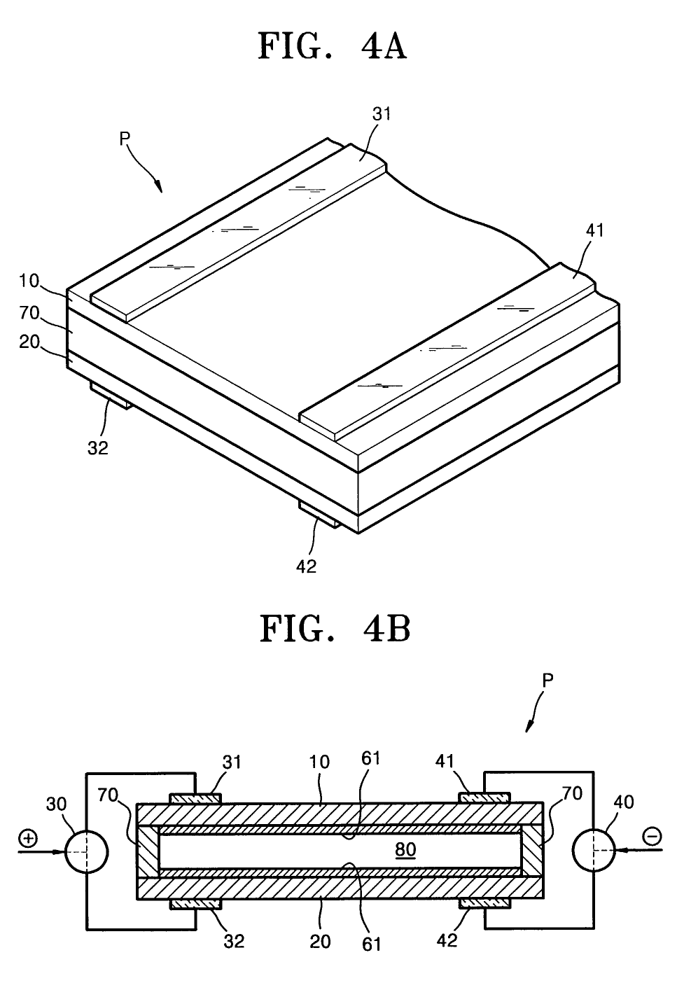

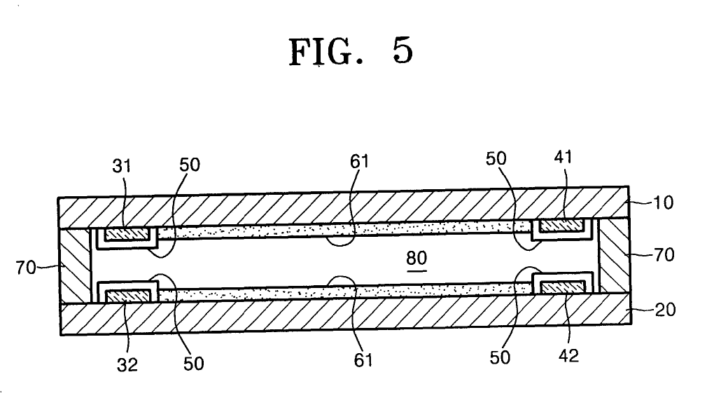

Referring to FIGS. 4A and 4B, in a plasma flat lamp according to a first preferred embodiment of the present invention, an upper plate 10 and a lower plate 20 are separated a predetermined distance from each other and a discharge space 80 filled with a discharge gas is formed therebetween.

A fluorescent layer 61 is formed on each of the upper and lower plates 10 and 20. Pairs of first electrodes 31 and 32 and second electrodes 41 and 42 are provided on the outer surfaces of the upper and lower plates 10 and 20. The pairs of electrodes 31 and 32, and 41 and 42 are arranged to face each other with respect to the discharge space 80. The first upper electrode 31 and the first lower electrode 32 facing each other maintain the same electric potential so that discharge is not induced therebetween. Also, the second upper electrode 41 and the second lower electrode 42 facing each other maintain the same electric potential so that discharge is not induced therebetween. A predetermined difference in electric potential is present between the first electrode pair 31 and 32 and the second electrode pair 41 and 42 so that discharge is induced between the electrode pairs in a direction parallel to the upper plate 10 or the lower plate 20. The first upper plate electrode 31 and the first lower plate electrode 32 constituting the first electrode pair 31 and 32 are electrically connected. The first upper plate electrode 31 and the first lower plate electrode 32 are directly and electrically connected, or are connected by an electric connection unit 30 which can prevent electric interference therebetween and simultaneously maintain the same electric potential.

The second electrode pair 41 and 42 are connected in the same manner as the first electrode pair 31 and 32. That is, the second upper plate electrode 41 and the second lower plate electrode 42 constituting the second electrode pair 41 and 42 are electrically connected. The second upper plate electrode 41 and the second lower plate electrode 42 are directly and electrically connected, or are connected by an electric connection unit 40 which can prevent electric interference therebetween and simultaneously maintain the same electric potential.

The plasma flat lamp shown in FIGS. 4A and 4B has the electrodes 31, 32, 41, and 42 that are not exposed to the discharge space. Electric power applied to the first and second electrode pairs is an alternating voltage or direct current pulse voltage. Since a pure direct current voltage cannot sustain discharge, it cannot be applied to the plasma flat lamp shown in FIGS. 4A and 4B.

FIG. 5 shows a plasma flat lamp according to a second preferred embodiment of the present invention.

The flat lamp of the present invention shown in FIG. 5 is different from the flat lamp shown in FIGS. 4A and 4B in the position of electrodes. In the flat lamp shown in FIGS. 4A and 4B, the electrodes are formed on the outer surfaces of the upper and lower plates 10 and 20. In the second preferred embodiment of the flat lamp of FIG. 5, the electrodes are formed on the inner surfaces of the upper and lower plates 10 and 20.

Referring to FIG. 5, a discharge space 80 filled with a discharge gas is formed between the upper and lower plates 10 and 20 which are separated a predetermined distance from each other by the wall portion 70. The fluorescent layer 61 is formed on each of the inner surfaces of the upper and lower plates 10 and 20. The pairs of the first electrodes 31 and 32 and the second electrodes 41 and 42 are provided on the inner surfaces of the upper and lower plates 10 and 20, close to the wall portion 70. Dielectric layers 50 are formed on each of the electrodes 31, 32, 41, and 42. The dielectric layers 50 are optional in the structure of the present preferred embodiment. The structure of driving voltage for the plasma flat lamp according to the second preferred embodiment of the present invention shown in FIG. 5 is the same as that described with reference to FIGS. 4A and 4B.

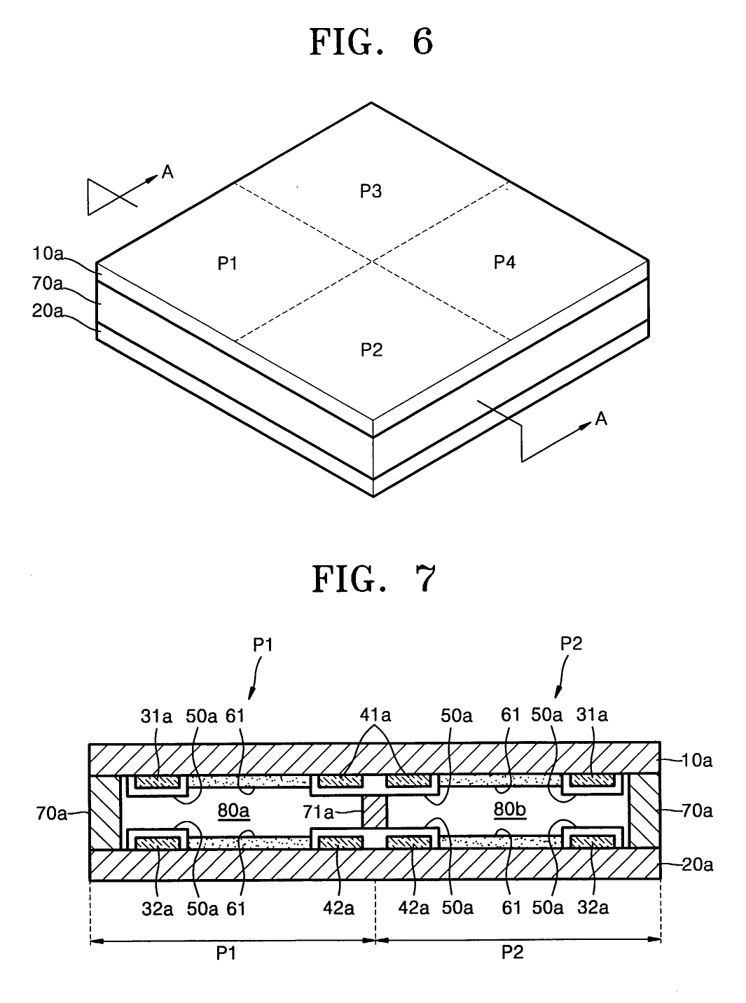

FIG. 6 shows a plasma flat lamp according to a third preferred embodiment of the present invention in which the structures according to the second preferred embodiment shown in FIG. 5 are arranged in an array.

As shown in FIG. 6, the entire lamp p is divided into unit discharge areas P1, P2, P3, and P4, each having an independent discharge space. Each of the unit discharge areas P1, P2, P3, and P4 has separate discharge electrodes and the structure of each area is similar to the structure shown in FIG. 5. FIG. 7 is a sectional view taken along line A-A of FIG. 6. Referring to FIG. 7 an upper plate 10a and a lower plate 20a are separated a predetermined distance from each other by a wall portion 70a and a discharge space is provided therebetween. A spacer 71a is provided in the discharge space to section the discharge space into unit discharge spaces 80a and 80b and prevent a lamp from being broken due to a difference in pressure between the inside and the outside of the lamp.

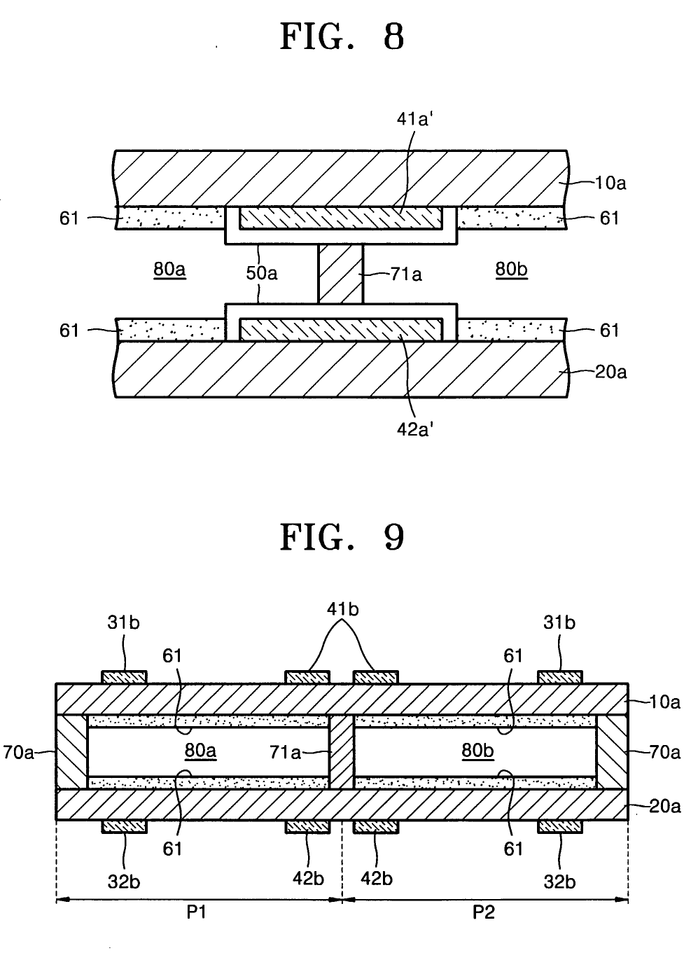

Each of the unit discharge spaces 80a and 80b has an independent discharge structure. That is, the discharge spaces 80a and 80b filled with a discharge gas and maintaining a predetermined distance from each other by the wall portion 70a and the spacer 71a are formed in each of the discharge spaces P1 and P2 between the upper and lower plates 10a and 20a. The fluorescent layer 61 is formed on each of the inner surfaces of the upper and lower plates 10a and 20a of each of the discharge spaces 80a and 80b. A first pair of electrodes 31a and 32a and a second pair of electrodes 41a and 42a are provided on the inner surfaces of the upper and lower plates 10a and 20a in each of the discharge spaces 80a and 80b, close to the wall portion 70a or the spacer 71a. A dielectric layer 50a is formed on each of the electrodes 31a, 32a, 41a, and 42a. The above structure is useful when a large scale of illumination is needed. In the above structure, the second electrodes 41a on the upper plate 10a are electrically connected and the second electrodes 42a on the lower plate 20a are electrically connected. As shown in FIG. 8, each of the second electrodes 41a on the upper plate 10a and the second electrodes 42a on the lower plate 20a can be formed integrally as upper and lower common electrodes 41a′ and 42a′ and extended toward each of the unit discharge spaces 80a and 80b with respect to the spacer 71 disposed therebetween.

FIG. 9 is a sectional view of a fourth preferred embodiment of the present invention in which the first preferred embodiment shown in FIGS. 4A and 4B is applied to the array structure of the flat lamp shown in FIGS. 6 and 7. Referring to FIG. 9, the upper plate 10a and the lower plate 20a are maintained with a predetermined distance and a discharge space is provided therebetween. The spacer 71a is provided in the discharge space to divide the discharge space into the unit discharge spaces 80a and 80b and prevent the lamp from being broken due to a difference in pressure between the inside and outside of lamp. The discharge spaces 80a and 80b filled with a discharge gas and maintaining a predetermined distance by the wall portion 70a and the spacer 71a are formed in the discharge areas P1 and P2 between the upper and lower plates 10a and 20a. The fluorescent layer 61 is formed on each of the inner surfaces of the upper and lower plates 10a and 20a. A first pair of electrodes 31b and 32b and a second pair of electrodes 41b and 42b are provided on the outer surfaces of the upper and lower plates 10a and 20a corresponding to the respective discharge spaces 80a and 80b, close to the wall portion 70a or the spacer 71a. A separate protective layer can be formed on each of the electrodes 31b, 32b, 41b, and 42b. The above structure is useful when a large scale of illumination is needed. In the above structure, the second electrodes 41b on the upper plate 10a are electrically connected and the second electrodes 42b on the lower plate 20a are electrically connected. As shown in FIG. 8, each of the second electrodes 41b on the upper plate 10a and the second electrodes 42b on the lower plate 20a can be formed integrally.

In the above-described preferred embodiments, a reflection layer (not shown) can be interposed between a lower plate (not shown) and the fluorescent layer on the lower plate to reflect light proceeding toward the lower plate back to the upper plate, thus improving luminance. The reflection layer may also be formed at a portion where improvement of luminance is expected, for example, the wall portion. In the above-described where the electrode is formed in the discharge space, when the dielectric layer is not formed on the electrode, the lamp can be driven by a direct current pulse voltage. When there is dielectric and the electrodes are formed on the outer surfaces of the upper and lower plates, the lamp can be driven by an alternating current voltage or an alternating or a direct current pulse voltage.

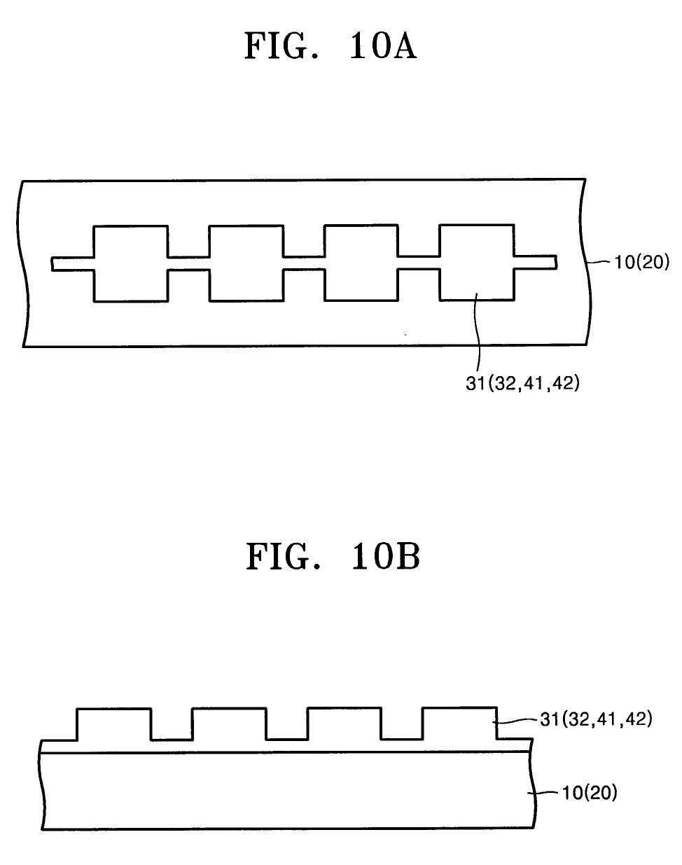

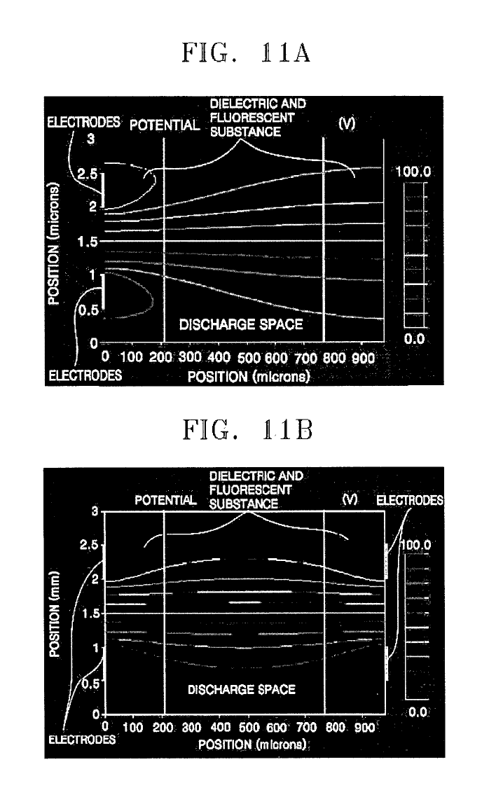

The flat lamp of the present invention is operated in a driving method which is well known. A plasma discharge is generated by a voltage applied between the electrodes in the discharge space filled with a discharge gas and the plasma discharge is sustained. Here, high temperature electrons to excite neutral gas atoms and molecules are generated. Ultraviolet rays generated as the atoms and molecules in excited states excited by the electrons fall to the ground state excite the fluorescent layer coated in the discharge space to generate visible rays. To prevent the electrodes coated on the upper plate from being seen by an observer, the upper plate electrodes and the dielectric are formed of substance exhibiting a high light transmittance or a diffuser sheet can be added on the upper plate. To prevent a discharge contraction and encourage a stable discharge, as shown in FIG. 10A, the electrode 10 can be formed such that a portion having a narrow width and a portion having a great width are repeated periodically or, as shown in FIG. 10B, the heights of the electrode 31 and the dielectric layer of the upper plate 10 or the lower plate 20 change periodically. When the electrodes are formed at the outer surfaces of the upper and lower plats, the upper and lower plates work as dielectric. Thus, making the surface of glass uneven has the same effect of giving a change in the height of the dielectric layer.

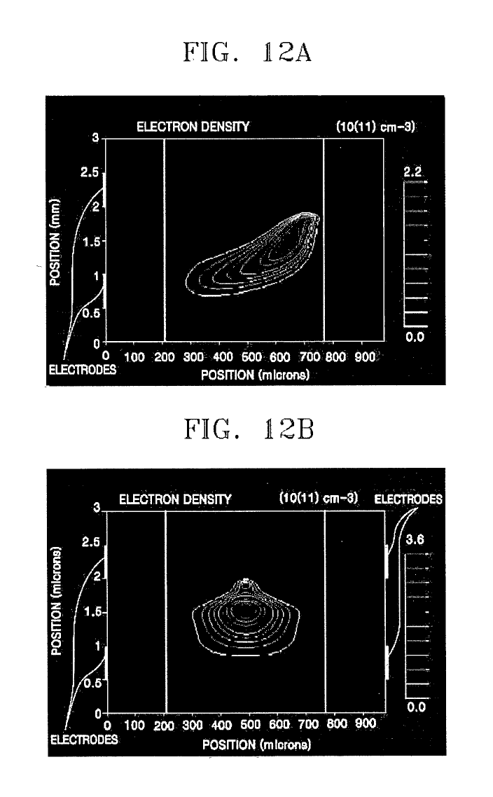

FIGS. 11A through 14B show the results of simulation of a discharge feature of the flat lamp according to the present invention.

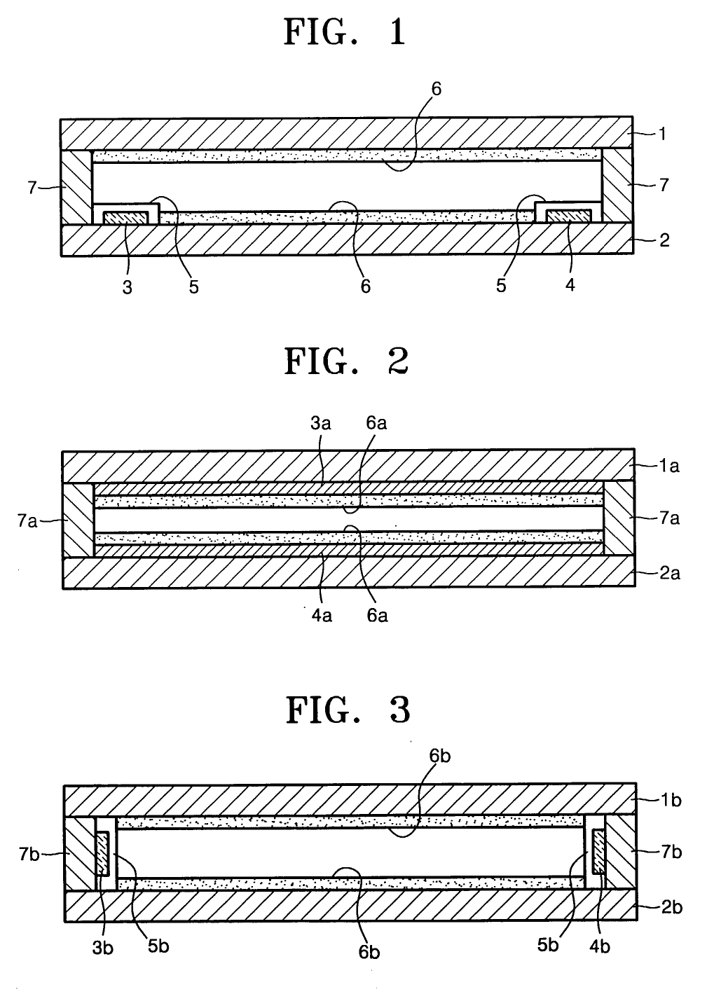

FIGS. 11A and 11B show distribution of electric potential generating under the same conditions with respect to the surface discharge flat lamp in which electrodes are formed on the lower plate like the conventional flat lamp shown in FIG. 1 and the flat lamp of the present invention shown in FIG. 5. In FIGS. 11A and 11B, the distribution of electric potential around the electrodes are curved similarly so that contraction of discharge is less by far compared to a general opposed electrode flat lamp and an effect of decreasing in life span by sputtering is small. However, since the distribution of electric field at the central portion of the flat lamp shown in FIG. 11B is similar to that of the opposed electrode flat lamp, instead of that for the surface discharge flat lamp in FIG. 11A, that is, the electric field is distributed around the center of the lamp.

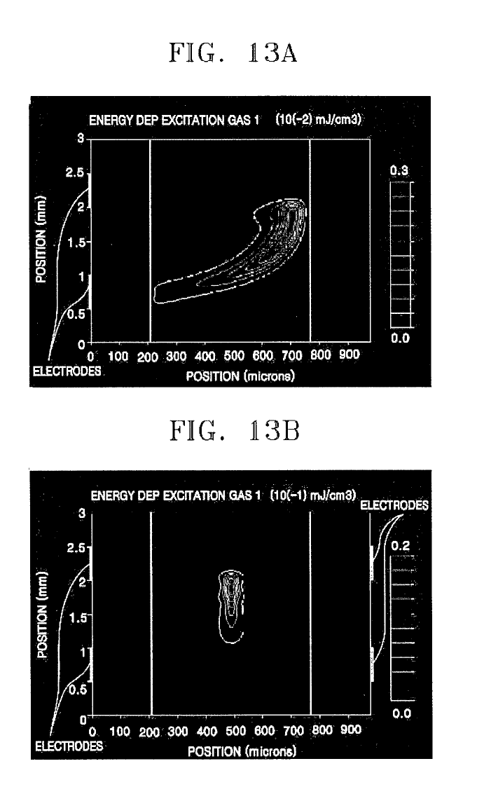

FIGS. 12A and 12B show distribution of density of electrons with respect to the conventional surface discharge flat lamp of FIG. 1 and the flat lamp according to the present invention of FIG. 5. In the flat lamp according to the present invention shown in FIG. 12B, it can be seen that electrons are mainly distributed at the center compared to the density of electrons of the conventional flat lamp of FIG. 12A, so that loss of diffusion, that is, electrons or ions hit the wall portion and disappear, is less.

FIGS. 13A and 13B show the distribution of energy used to excite Xe with respect to the conventional surface discharge flat lamp and the flat lamp according to the present invention. When the excited Xe atoms or molecules fall to the ground state, ultraviolet rays are generated and the ultraviolet rays excite fluorescent substance to generate visible rays. Thus, in the same structure, comparison of energy used to excite Xe actually corresponds to comparison of luminance of light emission. In the flat lamp of the present invention, like the case of electron distribution, the energy is mainly distributed at the center so that the density of energy is higher than that of the conventional surface discharge flat lamp of FIG. 1.

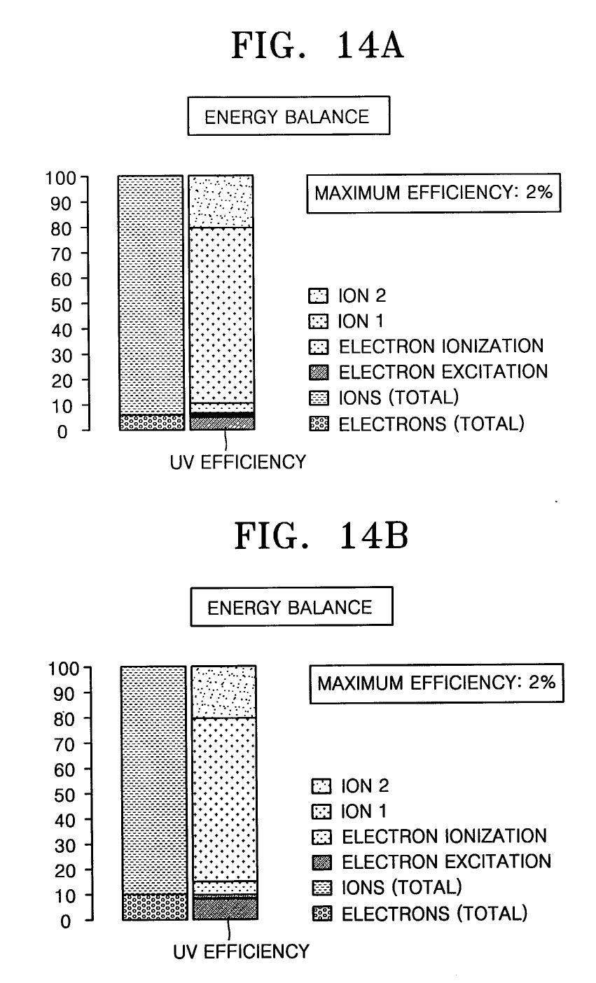

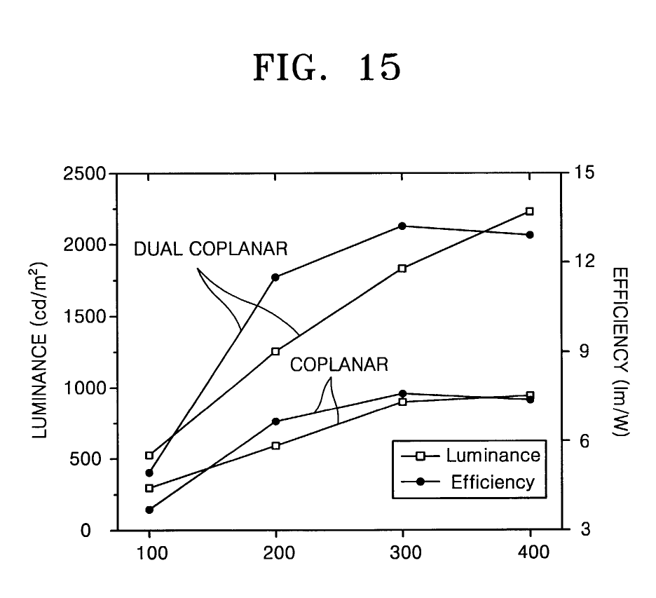

FIGS. 14A and 14B show the use of input energy by percentage in the conventional flat lamp and the flat lamp according to the present invention, respectively. Since the energy which contributes to actual light emission is the energy used to excite neutral particles by electrons, the efficiency of light emission can be compared by comparing the ratio of the energy used for the excitation with respect to the overall energy. The ratio of the energy used for the excitation with respect to the overall energy is referred to as a UV efficiency. As shown in FIGS. 14A and 14B, under the same conditions, the UV efficiency of the flat lamp of the present invention of FIG. 14B is 5% which is higher than 2% of the conventional flat lamp shown in FIG. 14A.

FIG. 15 shows the result of a test of actual products of the conventional flat lamp and the flat lamp according to the present invention having the same size with respect to a mixed gas of Xe(4%)/Ne. A driving frequency is 15.2 kHz, the flat lamps are driven by AC pulse, and the peak voltage of a driving pulse is 2.8 kV. The luminance and efficiency of the flat lamp of the present invention are higher than those of the conventional flat lamp.

As described above, the plasma flat lamp according to the present invention has a stable discharge feature which is a merit of the conventional surface discharge flat lamp and a high luminance of light emission which is a feature of the facing electrodes discharge type, while not having a low luminance and unstable discharge feature of the conventional surface discharge type flat lamp and facing electrodes discharge flat lamp, respectively.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A plasma flat lamp comprising:
an upper plate;
a lower plate separated a predetermined distance from the upper plate;
a wall portion for forming a sealed discharge space between the upper and lower plates;
a discharge gas filled in the discharge space;
a first pair of electrodes including a first upper plate electrode and a first lower plate electrode arranged to face each other on each of the upper and lower plates with the discharge space interposed therebetween; and
a second pair of electrodes including a second upper plate electrode separated a predetermined distance from the first upper plate electrode and a second lower plate electrode separated a predetermined distance from the first lower plate electrode arranged to face each other on each of the upper and lower plates with the discharge space interposed therebetween.

2. The plasma flat lamp as claimed in claim 1, wherein the first and second electrode pairs are formed on the outer surfaces of the upper and lower plates.

3. The plasma flat lamp as claimed in claim 1, wherein the first and second electrode pairs are formed on the inner surfaces of the upper and lower plates.

4. The plasma flat lamp as claimed in claim 3, wherein a dielectric layer is formed on each of the electrodes forming the electrode pairs so that the electrodes are in a non-contact state with respect to the discharge gas.

5. The plasma flat lamp as claimed in claim 1, wherein a reflection layer is formed between a lower plate and a fluorescent layer formed on the inner surface of the lower plate.

6. The plasma flat lamp as claimed in claim 2, wherein a reflection layer is formed between a lower plate and a fluorescent layer formed on the inner surface of the lower plate.

7. The plasma flat lamp as claimed in claim 3, wherein a reflection layer is formed between a lower plate and a fluorescent layer formed on the inner surface of the lower plate.

8. The plasma flat lamp as claimed in claim 4, wherein a reflection layer is formed between a lower plate and a fluorescent layer formed on the inner surface of the lower plate.

9. The plasma flat lamp as claimed in claim 1, wherein a reflection layer is formed on the inner surface of the wall portion.

10. The plasma flat lamp as claimed in claim 2, wherein a reflection layer is formed on the inner surface of the wall portion.

11. The plasma flat lamp as claimed in claim 3, wherein a reflection layer is formed on the inner surface of the wall portion.

12. The plasma flat lamp as claimed in claim 4, wherein a reflection layer is formed on the inner surface of the wall portion.

13. The plasma flat lamp as claimed in claim 1, wherein the first and second upper plate electrodes are formed of light transmitting substance.

14. The plasma flat lamp as claimed in claim 2, wherein the first and second upper plate electrodes are formed of light transmitting substance.

15. The plasma flat lamp as claimed in claim 3, wherein the first and second upper plate electrodes are formed of light transmitting substance.

16. The plasma flat lamp as claimed in claim 4, wherein the first and second upper plate electrodes are formed of light transmitting substance.

17. A plasma flat lamp comprising:
an upper plate;
a lower plate separated a predetermined distance from the upper plate;
a wall portion for forming a sealed discharge space between the upper and lower plates;
a discharge gas filled in the discharge space;
a spacer for dividing the discharge space into a plurality of unit discharge spaces;
a plurality of first electrode pairs including a first upper plate electrode and a first lower plate electrode arranged to face each other on each of the upper and lower plates with the discharge space interposed therebetween; and
a plurality of second electrode pairs including a second upper plate electrode separated a predetermined distance from the first upper plate electrode and a second lower plate electrode separated a predetermined distance from the first lower plate electrode arranged to face each other on each of the upper and lower plates with the discharge space interposed therebetween.

18. The plasma flat lamp as claimed in claim 17, wherein the first and second electrode pairs corresponding to the unit discharge spaces are formed on the outer surfaces of the upper and lower plates.

19. The plasma flat lamp as claimed in claim 17, wherein the first and second electrode pairs corresponding to the unit discharge spaces are formed on the inner surfaces of the upper and lower plates.

20. The plasma flat lamp as claimed in claim 19, wherein a dielectric layer is formed on each of the electrodes forming the electrode pairs so that the electrodes are in a non-contact state with respect to the discharge gas.

21. The plasma flat lamp as claimed in claim 17, wherein a reflection layer is formed between a lower plate and a fluorescent layer formed on the inner surface of the lower plate.

22. The plasma flat lamp as claimed in claim 18, wherein a reflection layer is formed between a lower plate and a fluorescent layer formed on the inner surface of the lower plate.

23. The plasma flat lamp as claimed in claim 19, wherein a reflection layer is formed between a lower plate and a fluorescent layer formed on the inner surface of the lower plate.

24. The plasma flat lamp as claimed in claim 20, wherein a reflection layer is formed between a lower plate and a fluorescent layer formed on the inner surface of the lower plate.

25. The plasma flat lamp as claimed in claim 17, wherein a reflection layer is formed on the inner surface of the wall portion.

26. The plasma flat lamp as claimed in claim 18, wherein a reflection layer is formed on the inner surface of the wall portion.

27. The plasma flat lamp as claimed in claim 19, wherein a reflection layer is formed on the inner surface of the wall portion.

28. The plasma flat lamp as claimed in claim 20, wherein a reflection layer is formed on the inner surface of the wall portion.

29. The plasma flat lamp as claimed in claim 17, wherein the first and second upper plate electrodes are formed of light transmitting substance.

30. The plasma flat lamp as claimed in claim 18, wherein the first and second upper plate electrodes are formed of light transmitting substance.

31. The plasma flat lamp as claimed in claim 19, wherein the first and second upper plate electrodes are formed of light transmitting substance.

32. The plasma flat lamp as claimed in claim 20, wherein the first and second upper plate electrodes are formed of light transmitting substance.
